(19) United States
(12) Patent Application Publication
(10) Pub. No.: US 2015/0063701 A1
(43) Pub. Date: Mar. 5, 2015

(54) ELECTRONIC DEVICE

(71) Applicant: KABUSHIKI KAISHA TOSHIBA, Tokyo (JP)

(72) Inventors: Takehiko Demiya, Mitaka-shi (JP); Eita Shuto, Tokyo (JP)

(73) Assignee: KABUSHIKI KAISHA TOSHIBA, Tokyo (JP)

(21) Appl. No.: 14/284,261

(22) Filed: May 21, 2014

(30) Foreign Application Priority Data
Aug. 30, 2013 (JP) 2013-179642

(51) Int. Cl. G06K 9/18

(52) U.S. Cl. CPC G06K 9/18
USPC 382/189

(57) ABSTRACT

According to at least one embodiment, an electronic device includes a display processor and a first processor. The display processor displays an electronic document and a plurality of handwritten strokes on the electronic document. The strokes include a linear first stroke having one end near an element in the electronic document, a second stroke near the one end of the first stroke, and a third stroke near another end of the first stroke. The first processor associates, if the first stroke, the second stroke, and the third stroke is input, the first stroke with the third stroke.

### CROSS-REFERENCE TO RELATED APPLICATIONS

This application is based upon and claims the benefit of priority from Japanese Patent Application No. 2013-179642, filed Aug. 30, 2013, the entire contents of which are incorporated herein by reference.

### FIELD

Embodiments described herein relate generally to an electronic device which processes a handwritten stroke on an electronic document.

### BACKGROUND

In recent years, various electronic devices, such as a tablet, a PDA, a smartphone, have been developed. Most of these types of electronic devices comprise a touchscreen display for facilitating an input operation by a user.

By touching a menu or an object displayed on the touchscreen display by a finger or the like, a user can instruct a portable electronic device to execute the function associated with the menu or the object.

Consideration has been made to add an annotation on a text of an electronic document, such as an HTML document, by a plurality of handwritten strokes manually input via the touchscreen display. What is desired is a method for managing an annotation added on the text of the electronic document.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing an outer appearance of an electronic device of an embodiment.

FIG. 2 is an illustration showing a cooperative operation between the electronic device of the embodiment and an external device.

FIG. 3 is an illustration showing a state in which a handwritten text is displayed on an electronic document.

FIG. 4 is a block diagram showing a system structure of a tablet computer.

FIG. 5 is a block diagram showing a function structure of a browser application program.

FIG. 6 is an illustration showing an area including a handwritten instruction line and a handwritten annotation within a handwritten text.

FIG. 7 is an illustration showing a relationship between strokes (characters, marks, graphics, or the like) handwritten by a user and time-series information.

FIG. 8 is an illustration showing time-series coordinates obtained for the handwritten text on the electronic document.

FIG. 9 is an illustration showing time-series information corresponding to handwritten arrow, “I”, “m”, and “p” of FIG. 3.

FIG. 10 is an illustration showing narrowing of an area by a straight line orthogonal to a direction of a handwritten arrow.

FIG. 11 is an illustration in which each stroke (point) is arranged on a temporal axis.

FIG. 12 is a flowchart showing steps of processing of extracting a handwritten instruction line and a handwritten annotation, and associating a stroke of the handwritten instruction line and the handwritten annotation.

### DETAILED DESCRIPTION

Various embodiments will be described hereinafter with reference to the accompanying drawings.

In general, according to one embodiment, an electronic device includes a display processor and a first processor. The display processor displays an electronic document and a plurality of handwritten strokes on the electronic document. The strokes include a linear first stroke having one end near an element in the electronic document, a second stroke near the one end of the first stroke, and a third stroke near another end of the first stroke. The first processor associates, if the first stroke, the second stroke, and the third stroke is input, the first stroke with the third stroke.

FIG. 1 is a perspective view showing an outer appearance of an electronic device of an embodiment. The electronic device is a pen-based portable electronic device configured to input data by handwriting with a pen or a finger, for example. The electronic device can be realized as a tablet computer, a notebook personal computer, a smartphone, a PDA, etc. It is hereinafter assumed that the electronic device is realized as a tablet computer 10. The tablet computer 10 is a portable electronic device which is also referred to as a tablet or a slate computer. As shown in FIG. 1, the tablet computer 10 comprises a main body 11 and a touchscreen display 17. The touchscreen display 17 is mounted such that it is laid over the top surface of the main body 11.

The main body 11 comprises a thin box-shaped housing. In the touchscreen display 17, a flat-panel display and a sensor configured to detect a contact position of a pen or a finger on a screen of the flat-panel display are incorporated. The flat-panel display may be a liquid crystal display (LCD), for example. As the sensor, a capacitive touchpanel or an electromagnetic induction-type digitizer, for example, can be used. It is hereinafter assumed that two types of sensors, i.e., a digitizer and a touchpanel, are both incorporated into the touchscreen display 17.

Each of the digitizer and the touchpanel is provided to cover the screen of the flat-panel display. The touchscreen display 17 can detect not only a touch operation on the screen using a finger, but also a touch operation on the screen using a pen 100. The pen may be an electromagnetic induction pen, for example. A user can perform a handwriting input operation on the touchscreen display 17 by using an external object (pen 100 or finger). During the handwriting input operation, a locus of movement of the external object (pen 100 or finger) on the screen, that is, a locus of a stroke (a trace of handwriting) handwritten by the handwriting input operation, is drawn in real time, and thereby the locus of each stroke is displayed on the screen. A locus of movement of the external object while the external object is touching the screen corresponds to one stroke. A set of many strokes namely, a set of many loci (traces of handwriting), corresponding to handwritten characters or graphics, constitutes a handwritten text.

In the present embodiment, the handwritten text is stored on a storage medium not as image data but as time-series information indicating coordinate series of the loci of strokes and the order relation between the strokes. In general, the time-series information means a set of time-series stroke data corresponding to respective strokes. Each stroke data corresponds to one handwritten stroke, and includes a coordinate data series (time-series coordinates) corresponding to respective points on the locus of this certain stroke. The order of arrangement of these items of stroke data corresponds to the order in which each of the strokes was written, that is, the stroke order.

The tablet computer 10 can read existing arbitrary time-series information from the storage medium, and display a handwritten text corresponding to the time-series information, that is, a locus corresponding to each of a plurality of strokes indicated by the time-series information, on a screen. Further, the tablet computer 10 has an editing function. The editing function can delete or move an arbitrary stroke or an arbitrary handwritten character or the like in the displayed handwritten text in accordance with an editing operation by a user with an “eraser” tool, a range selection tool, and various other tools. Further, the editing function includes the function of cancelling a history of several handwritten operations.

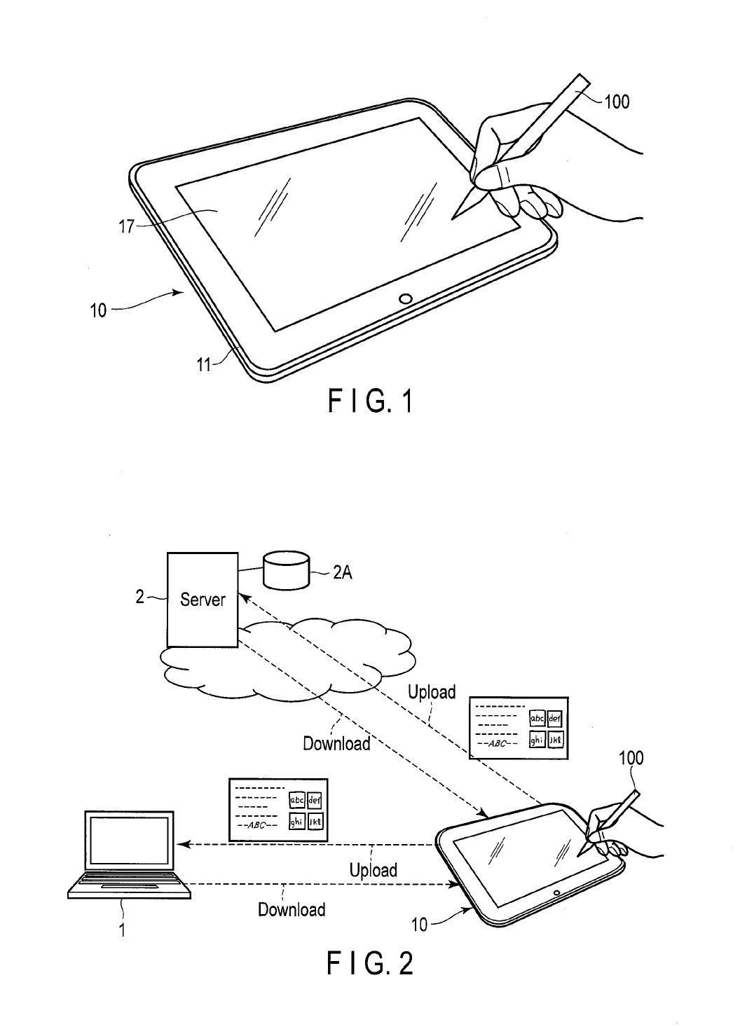

FIG. 2 shows an example of cooperative operation between the tablet computer 10 and an external device. The tablet computer 10 can cooperate with a personal computer 1 or a cloud. That is, the tablet computer 10 comprises a wireless communication device, such as a wireless LAN, and can wirelessly communicate with the personal computer 1. Further, the tablet computer 10 can communicate with a server 2 on the Internet. The server 2 may be a server which executes an online storage service and various other cloud computing services.

The personal computer 1 comprises a storage device, such as a hard disk drive (HDD). The tablet computer 10 can transmit time-series information (handwritten document) to the personal computer 1 over a network, and have it stored (uploaded) on an HDD of the personal computer 1. In order to ensure secure communication between the tablet computer 10 and the personal computer 1, it is possible to structure the personal computer 1 such that at the start of communication, the personal computer 1 authenticates the tablet computer 10. In such a case, a dialog for prompting a user to input an ID or a password may be displayed on a screen of the tablet computer 10. Alternatively, an ID of the tablet computer 10 may be automatically transmitted from the tablet computer 10 to the personal computer 1.

By virtue of the above structure, even if the amount of storage in the tablet computer 10 is small, it becomes possible for the tablet computer 10 to handle many items of time-series information (handwritten document) or a large amount of time-series information (handwritten document).

Further, the tablet computer 10 can read (download) at least one item of arbitrary time-series information recorded on the HDD of the personal computer 1, and display each locus of a stroke indicated by the read time-series information displayed on the screen of a display 17 of the tablet computer 10.

Further, a counterpart of communication of the tablet computer 10 may be the server 2 on the cloud which provides the storage service, as stated above, instead of the personal computer 1. The tablet computer 10 can transmit time-series information (handwritten document) over a network to the server 2, and have it stored (uploaded) on a storage device 2A of the server 2. Further, the tablet computer 10 can read (download) arbitrary time-series information stored on the storage device 2A of the server 2, and display each locus of a stroke indicated by the time-series information on the screen of the display 17 of the tablet computer 10.

As described above, in the present embodiment, a storage medium on which the time-series information is stored may be any of the storage device in the tablet computer 10, the storage device in the personal computer 1, and the storage device of the server 2.

The computer 10 can execute a browser application. The browser application displays an HTML document or an electronic document in a PDF file, etc., on a screen from an external server or the like. In addition, the browser application draws a locus of handwriting input stroke (a trace of handwriting) on the electronic document in real time, and the locus of each stroke is thereby displayed on the electronic document.

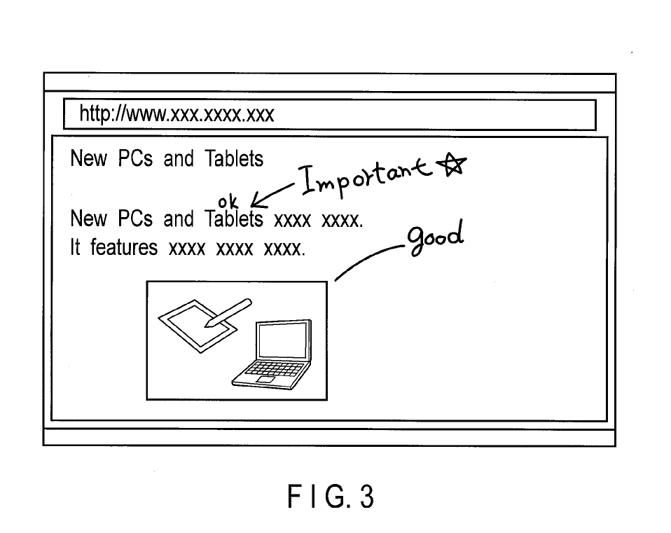

FIG. 3 is an illustration showing a state in which a handwritten text is displayed on an electronic document.

As shown in FIG. 3, handwritten “ok”, a handwritten arrow, handwritten “Important”, a handwritten pentagram, a handwritten line, and handwritten “good” are displayed on the electronic document.

The electronic document and the handwritten text (time-series information) prepared by handwriting on the electronic document are associated with each other and stored on a storage medium.

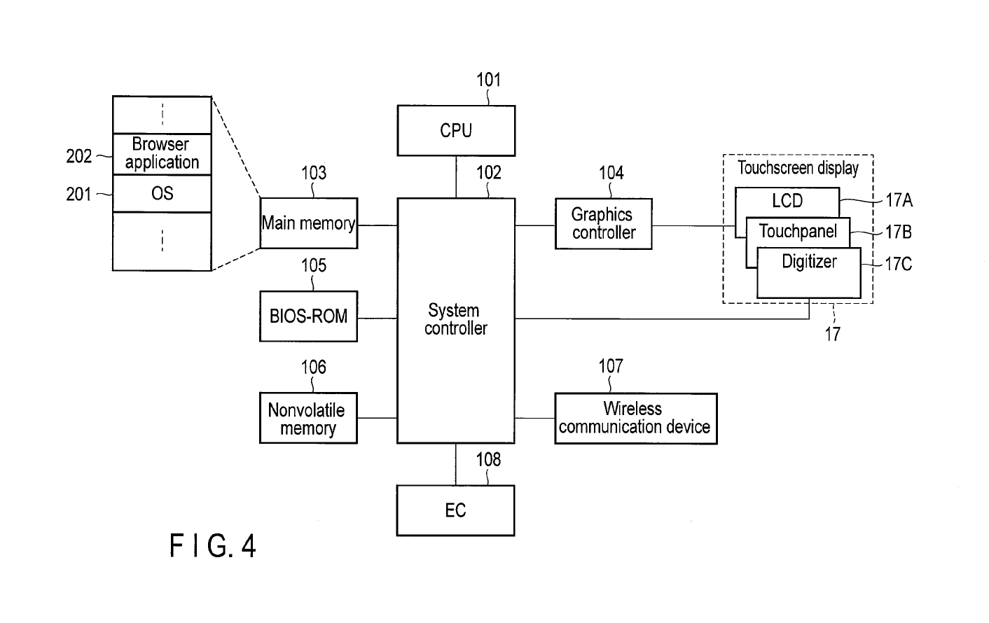

FIG. 4 is a diagram showing a system structure of the tablet computer 10.

As shown in FIG. 4, the tablet computer 10 comprises a CPU 101, a system controller 102, a main memory 103, a graphics controller 104, a BIOS-ROM 105, a nonvolatile memory 106, a wireless communication device 107, an embedded controller (EC) 108, etc.

The CPU 101 is a processor which controls an operation of various modules in the tablet computer 10. The CPU 101 executes various kinds of software loaded into the main memory 103 from the nonvolatile memory 106, which is the storage device. These kinds of software include an operating system (OS) 201, and various application programs. The application program includes a browser application program 202. The browser application program 202 acquires an electronic document, such as a hypertext mark up language (HTML) document, from a Web server, and has the function of displaying the electronic document, the function of preparing and displaying a handwritten text on the electronic document, the function of editing the handwritten text and the like.

In addition, the CPU 101 executes a Basic Input/Output System (BIOS) stored in the BIOS-ROM 105. The BIOS is a program for controlling hardware.

The system controller 102 is a device connecting between a local bus of the CPU 101 and various components. The system controller 102 includes a memory controller which access-controls the main memory 103. In addition, the system controller 102 has the function of executing communication with the graphics controller 104 through a serial bus conforming to the PCI EXPRESS standard.

The graphics controller 104 is a display controller for controlling an LCD 17A to be used as a display monitor of the tablet computer 10. A display signal generated by the graphics controller 104 is transmitted to the LCD 17A. The LCD 17A displays a screen image based on the display signal. On the LCD 17A, a touchpanel 17B and a digitizer 17C are arranged. The touchpanel 17B is a capacitive pointing device for inputting data on the screen of the LCD 17A. A contact position on the screen where a finger touches and movement of the contact position are detected by the touchpanel 17B. The digitizer 17C is an electromagnetic induction-type pointing device for inputting data on the screen of the LCD 17A A contact position on the screen where the pen 100 touches and movement of the contact position are detected by the digitizer 17C.

The wireless communication device 107 is a device configured to perform wireless communication, such as wireless LAN or 3G mobile communication. The EC 108 is a one-chip microcomputer including an embedded controller for power management. The EC 108 has the function of powering on or off the tablet computer 10 in accordance with an operation of a power button by a user.

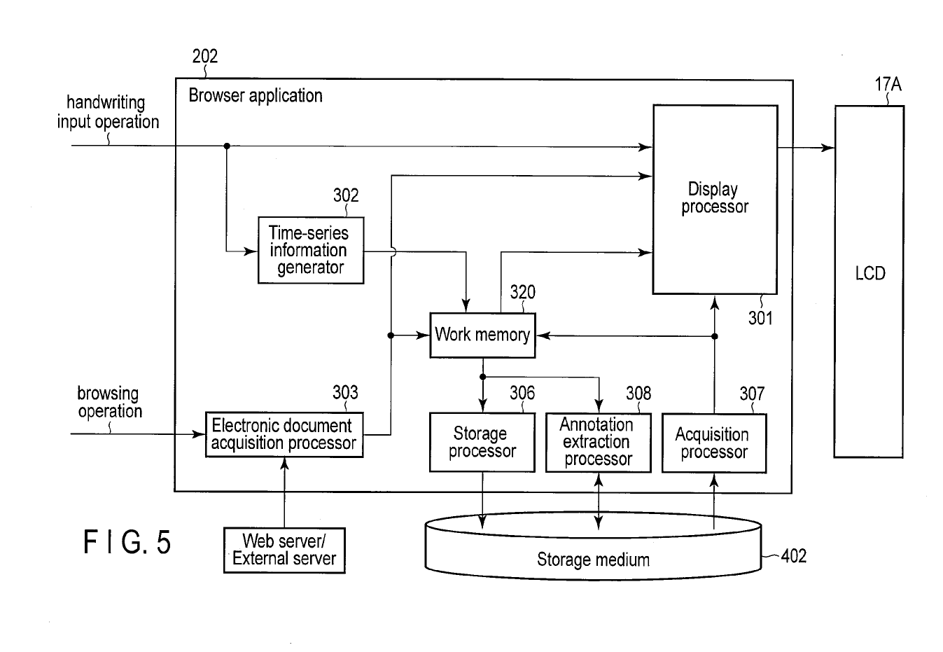

Next, with reference to FIG. 5, a function structure of the browser application program 202 will be described.

The browser application program 202 includes a display processor 301, a time-series information generator 302, an electronic document acquisition processor 303, a storage processor 306, an acquisition processor 307, an annotation extraction processor 308, etc.

The browser application program 202 creates, displays, and edits a handwritten text by using stroke data input by way of the touchscreen display 17. The touchscreen display 17 is configured to detect an occurrence of an event, such as “touch”, “move (slide)”, and “release”. The event “touch” shows that an external object has touched the screen. The event “move (slide)” shows that a contact position has moved while the external object is touching the screen. The event “release” shows that the external object has been released from the screen.

The electronic document acquisition processor 303 acquires an electronic document, such as an HTML document or a Portable Document Format (PDF) document from a Web server, etc., when a browsing operation is performed by a user. The browsing operation is an operation of specifying a uniform resource locator (URL) specified by a user, touching a link embedded in an electronic document displayed on the screen, or the like.

The display processor 301 displays the electronic document acquired by the electronic document acquisition processor 303 on the display screen of the LCD 17A. The electronic document may be temporarily stored in a work memory 320.

Moreover, the display processor 301 and the time-series information generator 302 receive the event of “touch” or “move (slide)” generated by the touchscreen display 17, and a handwriting input operation is thereby detected. The “touch” event includes coordinates of the contact position. The “move (slide)” event also includes coordinates of the contact position of the destination. Therefore, the display processor 301 and the time-series information generator 302 can receive a coordinate series corresponding to the locus of movement of the contact position from the touchscreen display 17.

The display processor 301 receives the coordinate series from the touchscreen display 17, and displays a locus of each stroke handwritten by the handwriting input operation using the pen 100, etc., on the electronic document, based on the coordinate series. By the display processor 301, the locus of the pen 100 while the pen 100 is touching the screen, that is, the locus of each stroke, is drawn on the electronic document.

The time-series information generator 302 receives the aforementioned coordinate series output from the touchscreen display 17, and generates time-series information based on the coordinate series. In this case, the time-series information, namely, coordinates and time stamp information corresponding to each point of the stroke may be temporarily stored in the work memory 320.

The storage processor 306 associates the electronic document and the generated time-series information with each other, and stores the associated electronic document and time-series information on a storage medium 402. The storage medium 402 may be either the storage device in the tablet computer 10 or a storage device via a network or USB, etc., as described above.

The acquisition processor 307 reads an electronic document and time-series information associated with the electronic document, which are already stored, from the storage medium 402. The electronic document and the time-series information associated with the electronic document, which have been read, are sent to the display processor 301. The display processor 301 analyzes the electronic document and the time-series information. Based on a result of the analysis, the display processor 301 displays the electronic document and a locus of each stroke indicated by the time-series information on the electronic document on the LCD 17A.

Based on the electronic document and the time-series information associated with the electronic document that are stored in the work memory 320 or the storage medium 402, the annotation extraction processor 308 performs processing for extracting stroke data corresponding to a handwritten instruction line (including a handwritten line and a handwritten arrow) indicating an element, and stroke data corresponding to a handwritten annotation (including handwritten characters and marks) from the time-series information. Further, the annotation extraction processor 308 stores information in which the handwritten instruction line is associated with the annotation on the storage medium 402.

In other words, the annotation extraction processor 308 perform processing for associating at least one item of stroke data including stroke data corresponding to the handwritten instruction line near an element (characters, graphics, etc.) in the electronic document with at least one item of stroke data corresponding to at least one locus positioned near the other end of the handwritten instruction line of a plurality of items of stroke data, of the plurality of items of stroke data corresponding to a plurality of loci input by handwriting on the electronic document. Further, the handwritten instruction line associates the element positioned near an end of the handwritten instruction line with the at least one item of stroke data positioned near the other end of the handwritten instruction line.

Next, before describing a method for extracting the handwritten line and the handwritten annotation, a relationship between strokes (characters, marks, graphics, etc.) handwritten by a user and time-series information will be described with reference to FIG. 7. In FIG. 7, an example is given based on the handwritten arrow shown in FIG. 3.

The handwritten arrow is represented by two strokes (a locus in the form of “-” (shaft 701) and a locus in the form of “<” (arrow head 702), that is, by two loci, handwritten by using the pen 100 or the like. The locus of the pen 100 in the form of “-” which is handwritten first is sampled in real time at regular time intervals, for example, and time-series coordinates SD11, SD12, . . . SD1h of the “-” stroke are thereby obtained. Similarly, a locus of the pen 100 in the form of “<” which is handwritten next is sampled, and time-series coordinates SD21, SD22, . . . SD2j of the “<” stroke are thereby obtained.

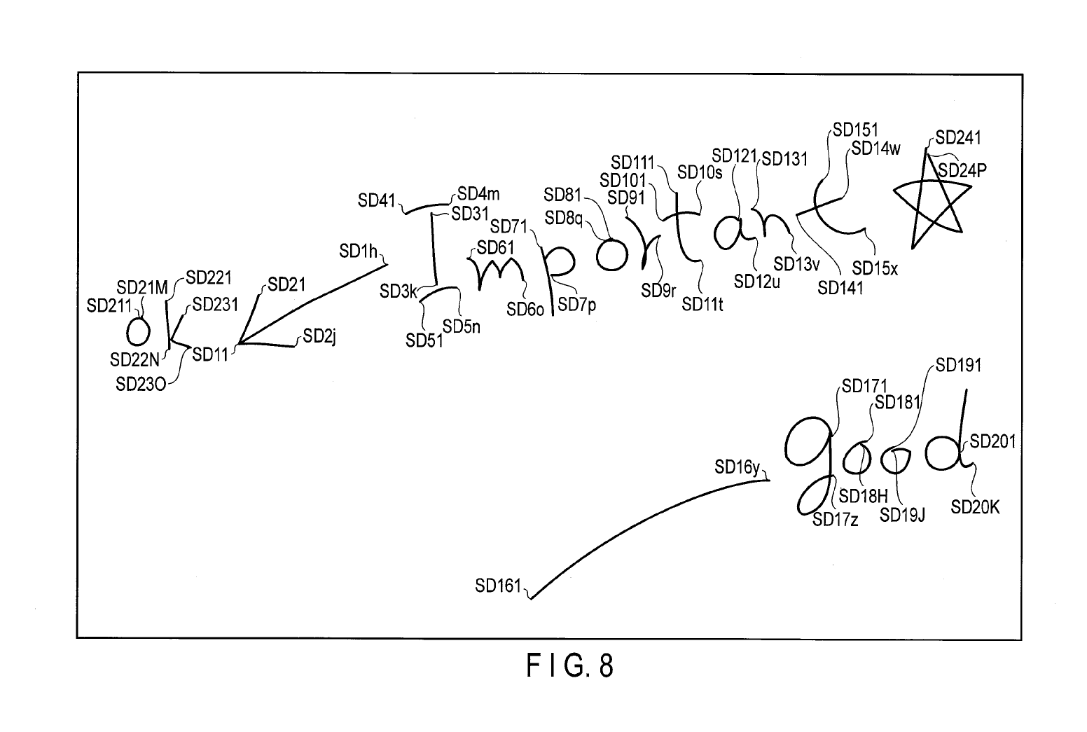

FIG. 8 is an illustration showing time-series coordinates obtained for the handwritten text on the electronic document. In FIG. 8, an illustration of the electronic document has been omitted.

After the handwritten arrow, a handwritten character string “Important” is added. The handwritten character string “Important” is formed by handwriting in the order of “I”, “m”, “p”, “o”, “r”, “t”, “a”, “n”, and “t”. In the same way, a locus of the pen 100 for “I” is sampled in real time at regular time intervals, for example, and time-series coordinates SD31, . . . SD3K, SD41, . . . SD4m, SD51, . . . SD5n of the “I” stroke are thereby obtained.

Similarly, a locus of the pen 100 for “m” is sampled in real time at regular time intervals, for example, and time-series coordinates SD61, . . . SD6o of the “m” stroke are thereby obtained. Similarly, a locus of the pen 100 for “p” is sampled in real time at regular time intervals, for example, and time-series coordinates SD71, . . . SD7p of the “p” stroke are thereby obtained. Similarly, a locus of the pen 100 for “o” is sampled in real time at regular time intervals, for example, and time-series coordinates SD81, . . . SD8q of the “o” stroke are thereby obtained. Similarly, a locus of the pen 100 for “r” is sampled in real time at regular time intervals, for example, and time-series coordinates SD91, . . . SD9r of the “r” stroke are thereby obtained. Similarly, a locus of the pen 100 for “t” is sampled in real time at regular time intervals, for example, and time-series coordinates SD101, . . . SD10s, SD111, . . . SD11t of the “t” stroke are thereby obtained. Similarly, a locus of the pen 100 for “a” is sampled in real time at regular time intervals, for example, and time-series coordinates SD121, . . . SD12u of the “a” stroke are thereby obtained. Similarly, a locus of the pen 100 for “n” is sampled in real time at regular time intervals, for example, and time-series coordinates SD131, . . . SD13v of the “n” stroke are thereby obtained. Similarly, a locus of the pen 100 for “t” is sampled in real time at regular time intervals, for example, and time-series coordinates SD141, . . . SD14w, SD151, . . . SD15x of the “t” stroke are thereby obtained.

A handwritten line is drawn. A locus of the pen 100 for the handwritten line is sampled in real time at regular time intervals, for example, and time-series coordinates SD161, . . . SD16y of the stroke in the form of the handwritten line are thereby obtained.

After the handwritten line, a character string “good” is added. The handwritten character string “good” is formed by handwriting in the order of “g”, “o”, “o”, and “d”. In the same way, a locus of the pen 100 for “g” is sampled in real time at regular time intervals, for example, and time-series coordinates SD171, . . . SD17z of the “g” stroke are thereby obtained. Similarly, a locus of the pen 100 for “o” is sampled in real time at regular time intervals, for example, and time-series coordinates SD181, . . . SD18H of the “o” stroke are thereby obtained. Similarly, a locus of the pen 100 for “o” is sampled in real time at regular time intervals, for example, and time-series coordinates SD191, . . . SD19J of the “o” stroke are thereby obtained. Similarly, a locus of the pen 100 for “d” is sampled in real time at regular time intervals, for example, and time-series coordinates SD201, . . . SD20K of the “d” stroke are thereby obtained.

After the handwritten character string “good”, a handwritten character string “ok” is added. The handwritten character string “ok” is formed by handwriting in the order of “o” and “k”. In the same way, a locus of the pen 100 for “o” is sampled in real time at regular time intervals, for example, and time-series coordinates SD211, . . . SD21M of the “o” stroke are thereby obtained. Similarly, a locus of the pen 100 for “k” is sampled in real time at regular time intervals, for example, and time-series coordinates SD221, . . . SD22N, SD231, . . . SD23O of the “k” stroke are thereby obtained.

After the handwritten character string “ok”, a handwritten pentagram is drawn. In the same way, a locus of the pen 100 for the handwritten pentagram is sampled in real time at regular time intervals, for example, and time-series coordinates SD241, . . . SD24P of the stroke in the form of the handwritten pentagram are thereby obtained.

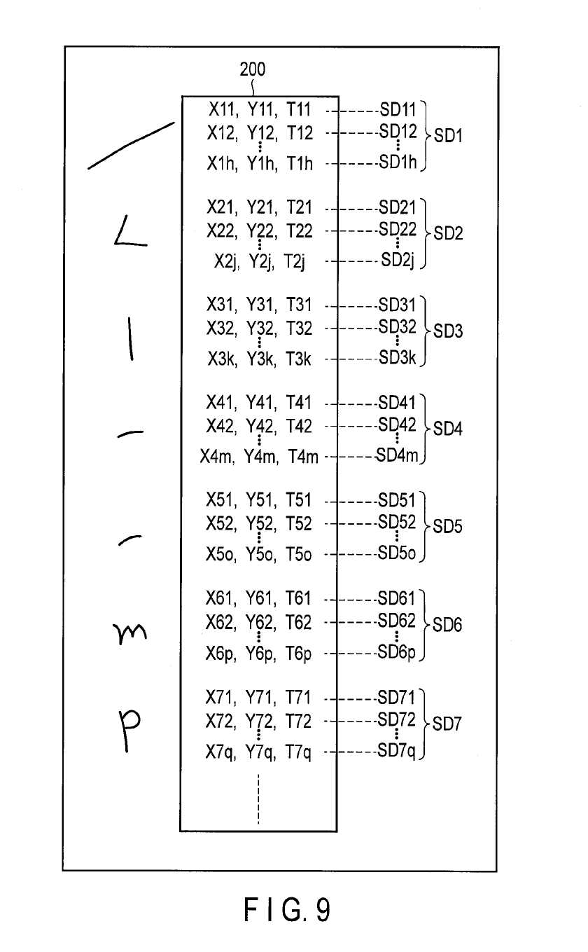

FIG. 9 shows time-series information 200 corresponding to the handwritten arrow, “I”, “m”, and “p” of FIG. 3. The time-series information includes a plurality of items of stroke data SD1, SD2, . . . SD7. In the time-series information 200, these items of stroke data SD1, SD2, . . . SD7 are arranged in time series in the order of handwriting, that is, in the order in which a plurality of strokes were handwritten.

In the time-series information 200, the first two items of stroke data SD1 and SD2 indicate the two strokes of the handwritten arrow, respectively. The third, the fourth, and the fifth items of stroke data SD3, SD4, and SD5 indicate the three strokes which constitute the handwritten character “I”, respectively. The sixth stroke data SD6 indicates one stroke which constitutes the handwritten character “m”. The seventh stroke data SD7 indicate the one stroke which constitute the handwritten character “p”.

Each item of stroke data includes a coordinate data series corresponding to one stroke (time-series coordinates), that is, a plurality of coordinates corresponding to respective points on a locus of one stroke. In each item of stroke data, a plurality of coordinates are arranged in time-series in the order in which the stroke was written. For example, with respect to the handwritten arrow, stroke data SD1 includes a coordinate data series (time-series coordinates) corresponding to respective points on the locus of the “-” stroke of the handwritten arrow, that is, h items of coordinate data SD11, SD12, . . . SD1h. The stroke data SD2 includes a coordinate data series corresponding to respective points on the locus of the “<” stroke of the handwritten arrow, that is, j items of coordinate data SD21, SD22, . . . SD2j.

Each item of coordinate data indicates an X-coordinate and a Y-coordinate corresponding to one point in the associated locus. For example, coordinate data SD11 indicates the X-coordinate (X11) and the Y-coordinate (Y11) of a starting point of the “-” stroke. SD1h indicates the X-coordinate (X1h) and the Y-coordinate (Y1h) of an end point of the “-” stroke.

Further, each item of coordinate data may include time stamp information T corresponding to a time point at which a point corresponding to this coordinate data was handwritten. The time point of handwriting may be either an absolute time (for example, year, month, day, hour, minute, second) or a relative time with reference to a certain time point. For example, an absolute time (for example, year, month, day, hour, minute, second) at which a stroke was started to be handwritten may be added to each item of stroke data as time stamp information, and a relative time indicative of a difference from the absolute time may further be added to each item of coordinate data in the stroke data as time stamp information T.

In this way, by using the time-series information in which time stamp information T is added to each item of coordinate data, a temporal relationship between strokes can be more accurately expressed.

Moreover, information (Z) indicative of writing pressure may be added to each item of coordinate data.

Next, a method for extracting a handwritten line and a handwritten annotation will be described.

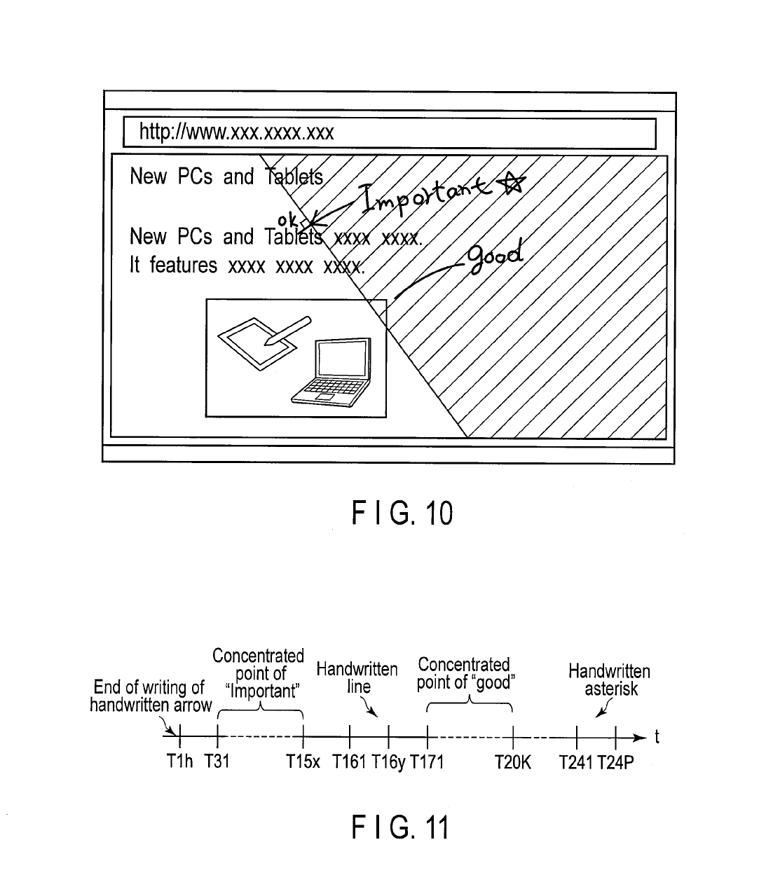

FIG. 10 shows narrowing of an area by a straight line orthogonal to a direction of a handwritten arrow. A line or an arrow as a first stroke, which is positioned near an element in an electronic document, is extracted from a handwritten text. A case in which the handwritten arrow is extracted is considered. When a straight line which is orthogonal to one end of a shaft of the handwritten arrow positioned near an element of the electronic document and passing the one end is drawn, it is considered that an annotation as a third stroke is provided in an area on the other end side of the shaft with reference to the straight line. Based on this idea, a handwritten character string “ok” as second strokes is excluded from the annotation.

FIG. 11 is a figure in which each stroke (point) of FIG. 8 is arranged on a temporal axis. A lateral axis is illustrated as time t. It is considered that an annotation accompanying a handwritten arrow is written later than the handwritten arrow. Then, a temporal relationship of stroke data shown in FIG. 8 is as follows:

T1h<T31<T15x<T161<T20K<T241

Further, writing of the annotation starts soon after the arrow (line) is written, and most of the strokes which constitute the annotation are written in a predetermined time as a bunch. This is considered as one block of a handwritten arrow and an annotation accompanying the handwritten arrow.

Therefore, a handwritten arrow and a handwritten character string “Important” accompanying the handwritten arrow, which corresponds to stroke data SD1 to SD15, are considered to be one block. Further, a handwritten line and a handwritten character string “good” accompanying the handwritten line, which correspond to stroke data SD16 to stroke data SD20, are considered to be a different block.

Meanwhile, if a handwritten pentagram is added later, on the temporal axis, the handwritten pentagram appears at a point far from the time when the strokes constituting the annotation of stroke data SD3 to SD15 are concentrated. Here, the stroke of the added annotation has the following features:

1. A handwritten arrow is not included as a lump on the temporal axis.

2. When a handwritten arrow is included as a lump on the temporal axis, a postscript stroke appears at a position far from the position on a plane where the strokes are concentrated in the lump according to time-series information. That is, when the strokes according to the previous time-series information are regarded as a distribution on the plane, there is a stroke outside the distribution.

A stroke which includes either of the above two features is treated as a stroke of a postscript annotation. After clustering the strokes by one block of the handwritten arrow and the annotation accompanying the handwritten arrow that are derived from the time-series information, a correction is made so that the postscript stroke is included in an appropriate block.

After clustering the strokes in units of blocks, Euclidean distance from each block may be used to determine which block the stroke of the postscript annotation refers to. Further, after clustering the strokes in units of one block, Mahalanobis distance from each block may be used to determine which block the stroke of the postscript annotation refers to.

After clustering the handwritten instruction line (including a handwritten arrow or a handwritten line) and the handwritten annotation by one block, and correcting the block so that the postscript stroke is included, the annotation extraction processor 308 associates the strokes corresponding to the handwritten instruction line and the strokes corresponding to the annotation in each block.

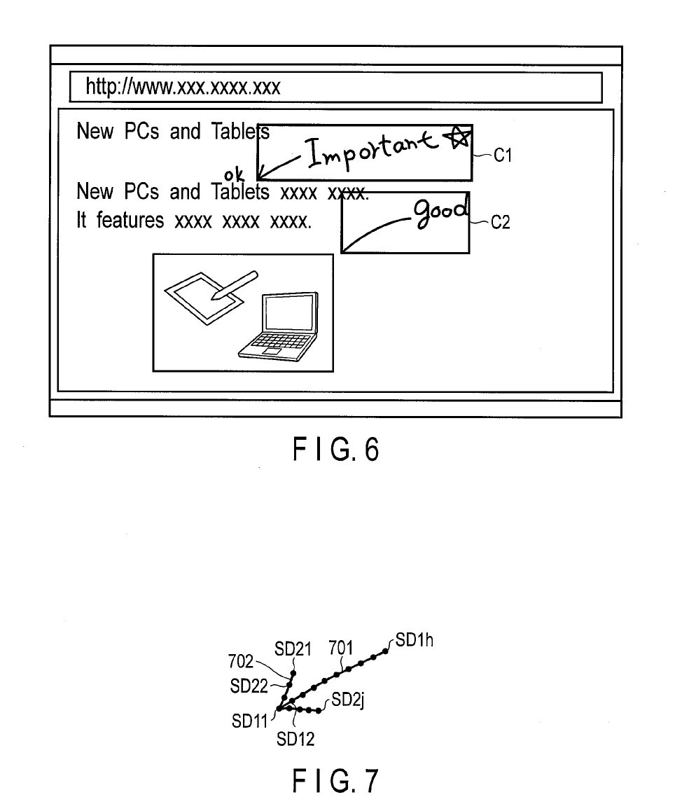

For example, in area C1 shown in FIG. 6, the annotation extraction processor 308 associates stroke data SD1 and SD2 with stroke data SD3 to SD15 and SD24. Further, for example, in area C2 shown in FIG. 6, the annotation extraction processor 308 associates stroke data SD16 with stroke data SD17 to SD20.

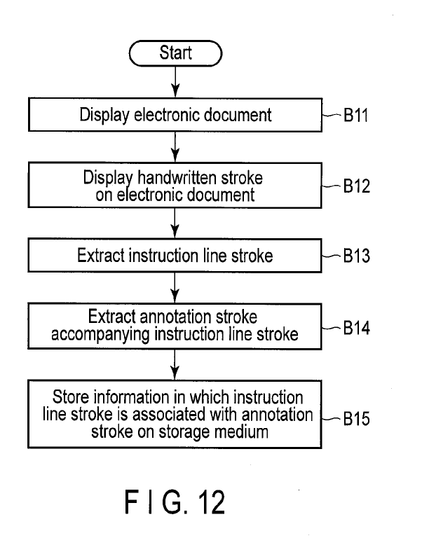

Next, steps of processing for extracting a handwritten instruction line and a handwritten annotation, and associating a stroke of the handwritten instruction line with the handwritten annotation will be described. FIG. 12 is a flowchart showing steps of processing for extracting a handwritten instruction line and a handwritten annotation, and associating a stroke of the handwritten instruction line with the handwritten annotation.

First of all, the display processor 301 displays an electronic document on the LCD 17A (block B11). The display processor 301 displays handwritten strokes on the electronic document (block B12). The annotation extraction processor 308 extracts an instruction line stroke corresponding to a handwritten instruction line from the handwritten strokes (block B13). The annotation extraction processor 308 extracts an annotation stroke corresponding to an annotation accompanying the handwritten instruction line from the handwritten strokes (block B14). The annotation extraction processor 308 stores information in which the instruction line stroke and the annotation stroke are associated with each other on the storage medium 402 (block B15).

By storing the information in which the instruction line stroke and the annotation stroke are associated with each other on the storage medium 402, it becomes possible to manage the annotation added to a text of the electronic document.

When a display position of the annotation is to be changed, the form of the handwritten instruction line may be changed according to the display position of the annotation.

Since various types of processing of the present embodiment can be realized by a computer program, it is possible to easily realize an advantage similar to that of the present embodiment by simply installing a computer program on an ordinary computer by way of a computer-readable storage medium containing the computer program, and executing this computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a display processor configured to display an electronic document and a plurality of handwritten strokes on the electronic document, the strokes comprising
a linear first stroke having one end near an element in the electronic document,
a second stroke near the one end of the first stroke, and
a third stroke near another end of the first stroke; and
a first processor configured to associate, if the first stroke, the second stroke, and the third stroke is input, the first stroke with the third stroke.

2. The device of claim 1, wherein the first processor is further configured to associate the first stroke with the third stroke when the first stroke corresponds to an arrow, the one end of the first stroke corresponding to a distal end of the arrow and the other end of the first stroke corresponding to a base part of the arrow.

3. The device of claim 1, wherein the first processor is further configured to associate the first stroke with the third stroke when the one end of the first stroke is positioned in an area which displays a character, a symbol, or graphics of the electronic document, and the other end of the first stroke is positioned in an area which displays a blank space of the electronic document.

4. The device of claim 1, wherein
the first stroke associates the element with the third stroke, and
when a display position of the third stroke is changed, a form of the first stroke is changed according to a display position of the third stroke.

5. A method of management comprising:
displaying an electronic document and a plurality of handwritten strokes on the electronic document, the strokes comprising
a linear first stroke having one end near an element in the electronic document,
a second stroke near the one end of the first stroke, and
a third stroke near another end of the first stroke; and
associating, when the first stroke is input, the first stroke with the third stroke.

6. The method of claim 5, further comprising associating the first stroke with the third stroke when the first stroke corresponds to an arrow, the one end of the first stroke corresponding to a distal end of the arrow and the other end of the first stroke corresponding to a base part of the arrow.

7. The method of claim 5, further comprising associating the first stroke with the third stroke when the one end of the first stroke is positioned in an area which displays a character, a symbol, or graphics of the electronic document, and the other end of the first stroke is positioned in an area which displays a blank space of the electronic document.

8. The method of claim 5, wherein
the first stroke associates the element with the third stroke, and
when a display position of the third stroke is changed, a form of the first stroke is changed according to a display position of the third stroke.

9. A computer-readable, non-transitory storage medium configured to store a computer program which is executable by a computer, the computer program controlling the computer to execute functions of:
displaying an electronic document and a plurality of handwritten strokes on the electronic document, the strokes comprising
a linear first stroke having one end near an element in the electronic document,
a second stroke near the one end of the first stroke, and
a third stroke near another end of the first stroke; and
associating, when the first stroke is input, the first stroke with the third stroke.

10. The program of claim 9, further comprising associating the first stroke with the third stroke when the first stroke corresponds to an arrow, the one end of the first stroke corresponding to a distal end of the arrow and the other end of the first stroke corresponding to a base part of the arrow.

11. The program of claim 9, further comprising associating the first stroke with the third stroke when the one end of the first stroke is positioned in an area which displays a character, a symbol, or graphics of the electronic document, and the other end of the first stroke is positioned in an area which displays a blank space of the electronic document.

12. The program of claim 9, wherein
the first stroke associates the element with the third stroke, and
when a display position of the third stroke is changed, a form of the first stroke is changed according to a display position of the third stroke.
